(19) United States
(12) Patent Application Publication
(10) Pub. No.: US 2024/0086870 A1
(43) Pub. Date: Mar. 14, 2024

(54) METHOD, INTERNET OF THINGS (IOT) SYSTEM, AND MEDIUM FOR DISPOSING EMERGENCY GAS SUPPLY OF SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Yuefei WU, Chengdu (CN); Xiaojun WEI, Chengdu (CN)

(73) Assignee: CHENGDU QINCHUAN IOT TECHNOLOGY CO., LTD., Chengdu (CN)

(21) Appl. No.: 18/510,578

(22) Filed: Nov. 15, 2023

(30) Foreign Application Priority Data
Oct. 23, 2023 (CN) 202311371304.4

(51) Int. Cl. G06Q 10/30; G06Q 50/06

(52) U.S. Cl. CPC G06Q 10/30; G06Q 50/06

(57) ABSTRACT

A method, an Internet of Things (IoT) system, and a medium for disposing emergency gas supply of smart gas are provided. The method comprises: obtaining gas data based on a data acquisition device; determining future predicted data of a gas pipeline network system based on the gas data and gas pipeline features; determining a future fault pipeline based on the future predicted data; determining target regions based on the future fault pipeline; and determining an emergency vehicle dispatch instruction based on the target regions.

### CROSS-REFERENCE TO RELATED APPLICATIONS

This application claims priority of the Chinese Patent Application No. 202311371304.4, filed on Oct. 23, 2023, the entire contents of which are hereby incorporated by reference.

### TECHNICAL FIELD

The present disclosure relates to the technical field of the Internet of Things (IoT), and in particular, to a method, an Internet of Things (IoT) system, and a medium for disposing emergency gas supply of smart gas.

### BACKGROUND

When a gas pipeline fault occurs, there may be a lag in gas supply, causing user dissatisfaction and complaints. Dispatching an emergency vehicle for temporary gas supply can ensure the stability of gas supply. However, if the dispatching of emergency vehicles is not clear and reasonable enough, it may not only consume large manpower, material resources, and time, but also may not obtain the expected results.

Aiming at the problem of reasonable selection of an emergency vehicle dispatch instruction, CN203147281U provides a mobile system for emergency natural gas supply, which realizes rapid response and emergency gas supply to situations such as the gas pipeline fault using a movable gas supply platform. However, due to the sudden and unpredictable nature of the gas pipeline fault, the emergency vehicle dispatch instruction of the system is constructed on the premise that the fault and other situations have occurred and been known, and there is still a lag in the restoration of gas supply.

Therefore, it is desirable to provide a method, an IoT system, and a medium for disposing emergency gas supply, which can determine a reasonable emergency dispatch instruction, thereby quickly and efficiently providing emergency gas supply, and improving the experience of gas users.

### SUMMARY

One or more embodiments of the present disclosure provide a method for disposing emergency gas supply of smart gas, comprising: obtaining gas data based on a data acquisition device, the gas data including at least one of gas flow data, gas pipeline temperature data, and gas pipeline air pressure data; determining future predicted data of a gas pipeline network system based on the gas data and gas pipeline features, the future predicted data including predicted pipeline fault data, and future gas data; determining a future fault pipeline based on the future predicted data; determining target regions based on the future fault pipeline, the target regions including a first predicted target region; and determining an emergency vehicle dispatch instruction based on the target regions, the emergency vehicle dispatch instruction including at least one of an emergency vehicle dispatch location and emergency vehicle dispatch time.

One or more embodiments of the present disclosure provide an internet of things (IoT) system for disposing emergency gas supply of smart gas, comprising a smart gas user platform, a smart gas service platform, a smart gas pipeline network safety management platform, a smart gas pipeline network sensor network platform, and a smart gas pipeline network object platform which interact in sequence. The smart gas pipeline network safety management platform may be configured to: obtain gas data based on a data acquisition device, the gas data including at least one of gas flow data, gas pipeline temperature data, and gas pipeline air pressure data; determine future predicted data of a gas pipeline network system based on the gas data and gas pipeline features, the future predicted data including predicted pipeline fault data, and future gas data; determine a future fault pipeline based on the future predicted data; determine target regions based on the future fault pipeline, the target regions including a first predicted target region; and determine an emergency vehicle dispatch instruction based on the target regions, the emergency vehicle dispatch instruction including at least one of an emergency vehicle dispatch location and emergency vehicle dispatch time.

One or more embodiments of the present disclosure provide a non-transitory computer-readable storage medium, comprising computer instructions that, when read by a computer, may direct the computer to implement the method for disposing emergency gas supply of smart gas.

### BRIEF DESCRIPTION OF THE DRAWINGS

FIG. 1 is a schematic diagram illustrating an exemplary internet of things (IoT) system for disposing emergency gas supply of smart gas according to some embodiments of the present disclosure;

FIG. 2 is a flowchart illustrating an exemplary method for disposing emergency gas supply of smart gas according to some embodiments of the present disclosure;

FIG. 3 is a schematic diagram illustrating an exemplary process of determining future predicted data according to some embodiments of the present disclosure;

FIG. 4A is a schematic diagram illustrating an exemplary degree of importance of a pipeline according to some embodiments of the present disclosure;

FIG. 4B is a schematic diagram illustrating an exemplary candidate predicted association pipeline according to some embodiments of the present disclosure; and

FIG. 5 is a flowchart illustrating an exemplary process of determining an emergency vehicle dispatch instruction according to some embodiments of the present disclosure.

### DETAILED DESCRIPTION

The accompanying drawings, which are to be used in the description of the embodiments, are briefly described below. The accompanying drawings do not represent the entirety of the embodiments.

As used herein, “system”, “device”, “unit” and/or “module” are used as a means of distinguishing between different levels of components, elements, parts, sections or assemblies. The words may be replaced by other expressions if other words would accomplish the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

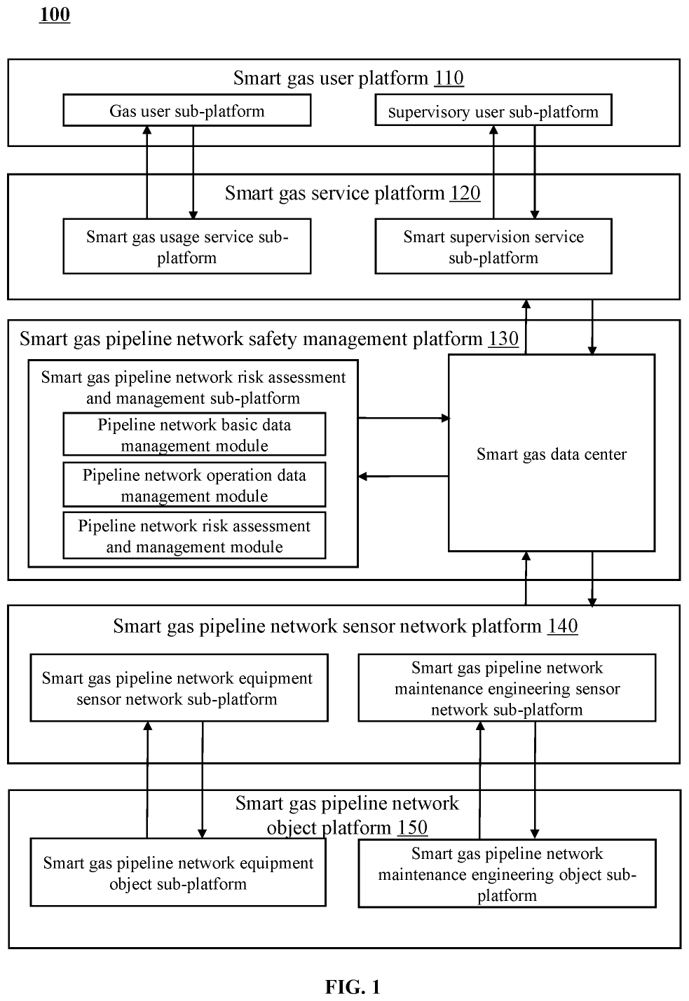

FIG. 1 is a schematic diagram illustrating an exemplary IoT system for disposing emergency gas supply of smart gas according to some embodiments of the present disclosure. The IoT system for disposing emergency gas supply of smart gas in the embodiments of the present disclosure will be described in detail below. It should be noted that the following embodiments are only used to explain the present disclosure and do not constitute a limitation of the present disclosure.

In some embodiments, as shown in FIG. 1, an (IoT) system 100 for disposing emergency gas supply of smart gas may include a smart gas user platform 110, a smart gas service platform 120, a smart gas pipeline network safety management platform 130, a smart gas pipeline network sensor network platform 140, and a smart gas pipeline network object platform 150 which connected in sequence.

The smart gas user platform 110 may be a platform for interacting with users. In some embodiments, the smart gas user platform 110 may be configured as a terminal device.

In some embodiments, the smart gas user platform 110 may include a gas user sub-platform and a supervisory user sub-platform.

The gas user sub-platform may be a platform that provides the gas users with data related to gas usage and solutions to gas problems. The gas user may be industrial gas users, commercial gas users, ordinary gas users, etc.

The supervisory user sub-platform may be a platform for supervisory users to supervise operation of the entire IoT system. The supervisory users may be personnel of a safety management department.

In some embodiments, the smart gas user platform 110 may send information, such as an emergency vehicle dispatch instruction, to the supervisory users based on the supervisory user sub-platform.

The smart gas service platform 120 may be a platform for communicating demand and control information of the users. The smart gas service platform 120 may obtain the emergency vehicle dispatch instruction, or the like, from the smart gas pipeline network safety management platform 130 (e.g., a smart gas data center) and send the emergency vehicle dispatch instruction, or the like, to the smart gas user platform 110.

In some embodiments, the smart gas service platform 120 may include a smart gas usage service sub-platform and a smart supervision service sub-platform.

The smart gas usage service sub-platform may be a platform that provides gas usage services for the gas users.

The smart supervision service sub-platform may be a platform that provides a supervisory demand for the supervisory users.

In some embodiments, the smart gas service platform 120 may send the emergency vehicle dispatch instruction to the supervisory user sub-platform based on the smart supervision service sub-platform.

The smart gas pipeline network safety management platform 130 may be a platform that coordinates and harmonizes the connection and collaboration between various functional platforms, and aggregates all the information of the IoT to provide functions of perception management and control management for an IoT operation system.

In some embodiments, the smart gas pipeline network safety management platform 130 may include a smart gas pipeline network risk assessment and management sub-platform and the smart gas data center.

The smart gas pipeline network risk assessment and management sub-platform may be a platform configured to determine the emergency vehicle dispatch instruction. In some embodiments, the smart gas pipeline network risk assessment and management sub-platform may include a pipeline network basic data management module, a pipeline network operation data management module, and a pipeline network risk assessment and management module. The smart gas pipeline network risk assessment and management sub-platform may analyze and process gas data and gas pipeline features using the aforementioned management modules.

The smart gas data center may be configured to store and manage all operation information of the IoT system 100 for disposing emergency gas supply of smart gas. In some embodiments, the smart gas data center may be configured as a storage device for storing data (e.g., the gas data, the gas pipeline features, etc.) related to disposing emergency gas supply.

In some embodiments, the smart gas pipeline network safety management platform 120 may perform information interaction with the smart gas service platform 120 and the smart gas pipeline network sensor network platform 140 through the smart gas data center. For example, the smart gas data center may send emergency vehicle dispatch instructions to the smart gas service platform 120. For example, the smart gas data center may send the emergency vehicle dispatch instruction to the smart gas service platform 120. As another example, the smart gas data center may send an instruction related to obtaining an operation status of the gas pipeline network system to the smart gas pipeline network sensor network platform 140 to obtain detection data of the smart gas pipeline network system.

The smart gas pipeline network sensor network platform 140 may be a functional platform configured to manage sensor communication. In some embodiments, the smart gas pipeline network sensor network platform 140 may be a functional platform for realizing functions of perception information sensor communication and control information sensor communication.

In some embodiments, the smart gas pipeline network sensor network platform 140 may include a smart gas pipeline network equipment sensor network sub-platform and a smart gas pipeline network maintenance engineering sensor network sub-platform configured to obtain operation information of smart gas pipeline network equipment and operation information of smart gas pipeline network maintenance engineering, respectively.

The smart gas pipeline network object platform 150 may be a functional platform for generating the perception information and executing the control information. For example, smart gas pipeline network object platform 150 may monitor and generate the operation information of the smart gas pipeline network equipment and the smart gas pipeline network maintenance engineering.

In some embodiments, smart gas pipeline network object platform 150 may include a smart gas pipeline network equipment object sub-platform and a smart gas pipeline network maintenance engineering object sub-platform.

In some embodiments, the smart gas pipeline network equipment object sub-platform may be configured as various types of data acquisition devices, such as a gas meter, a gas flow meter, a temperature and pressure sensor, or the like.

In some embodiments, the smart gas pipeline network maintenance engineering object sub-platform may be configured as equipment for disposing emergency gas supply, such as an emergency vehicle, or the like.

In some embodiments of the present disclosure, a closed information operation loop may be formed between the smart gas pipeline network object platform 150 and the smart gas user platform 110 based on the IoT system 100 for disposing emergency gas supply of smart gas, and coordinated and regulated under the unified management of the smart gas pipeline network safety management platform 130, to achieve informatization and intellectualization of disposal management for emergency gas supply of smart gas.

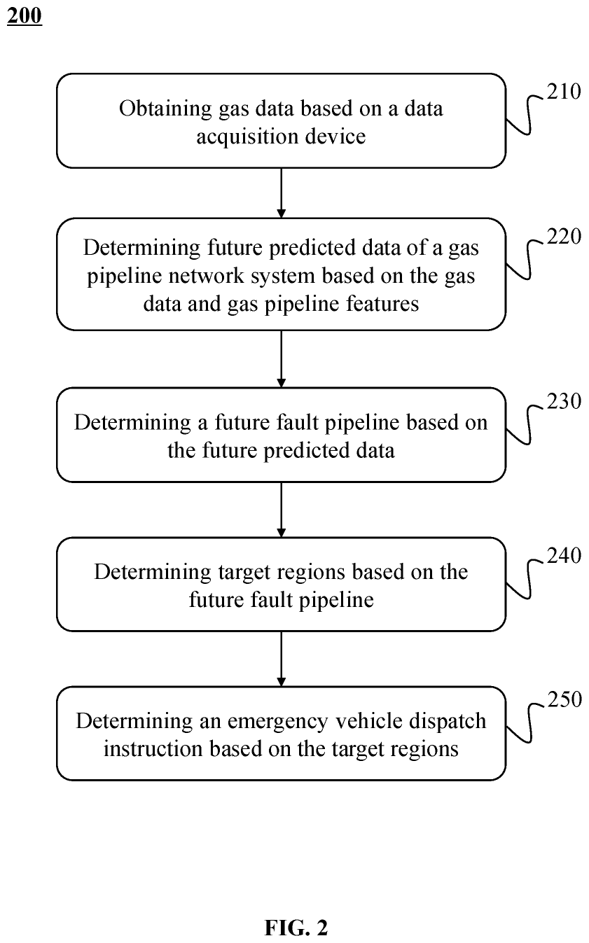

FIG. 2 is a flowchart illustrating an exemplary method for disposing emergency gas supply of smart gas according to some embodiments of the present disclosure. In some embodiments, a process 200 may be performed based on a smart gas pipeline network safety management platform. As shown in FIG. 2, the process 200 may include the following operations.

In 210, gas data may be obtained based on a data acquisition device.

The data acquisition device refers to a device or a component used to collect the gas data, e.g., a gas meter, a gas flow meter, a temperature and pressure sensor, or the like.

The gas data refers to data related to gas. In some embodiments, the gas data may include at least one of gas flow data, gas pipeline temperature data, and gas pipeline air pressure data.

In some embodiments, the smart gas pipeline network safety management platform may obtain the gas data collected by the data acquisition device of the smart gas pipeline network equipment object sub-platform based on the smart gas pipeline network equipment sensor network sub-platform.

In 220, future predicted data of a gas pipeline network system may be determined based on the gas data and gas pipeline features.

The gas pipeline features refer to features related to a gas pipeline. For example, the gas pipeline features may include a pipeline material, a pipeline structure, a pipeline specification, or the like. In some embodiments, the smart gas pipeline network safety management platform may obtain the gas pipeline features from an external database. The external database refers to a database other than the IoT system for disposing emergency gas supply of smart gas. The external database may store the gas pipeline features obtained from a pipeline manufacturer, actual measurement, or other sources.

The future predicted data refers to data related to the gas pipeline network at a predicted future time point. In some embodiments, the future predicted data may include predicted pipeline fault data and future gas data.

The predicted pipeline fault data refers to data related to a pipeline fault at the predicted future time point. For example, the predicted pipeline fault data may include whether a fault has occurred, a predicted fault location, a predicted fault time point, or the like.

The future gas data refers to gas data at the predicted future time point. For example, the future gas data may include predicted gas flow data of a pipeline, gas pipeline temperature data, gas pipeline air pressure data, or the like.

In some embodiments, the smart gas pipeline network safety management platform may determine the future predicted data in various ways. For example, the smart gas pipeline network safety management platform may determine the future predicted data of the gas pipeline network system by analyzing and processing the gas data and the gas pipeline features using various data analysis algorithms (e.g., regression analysis, discriminant analysis, etc.).

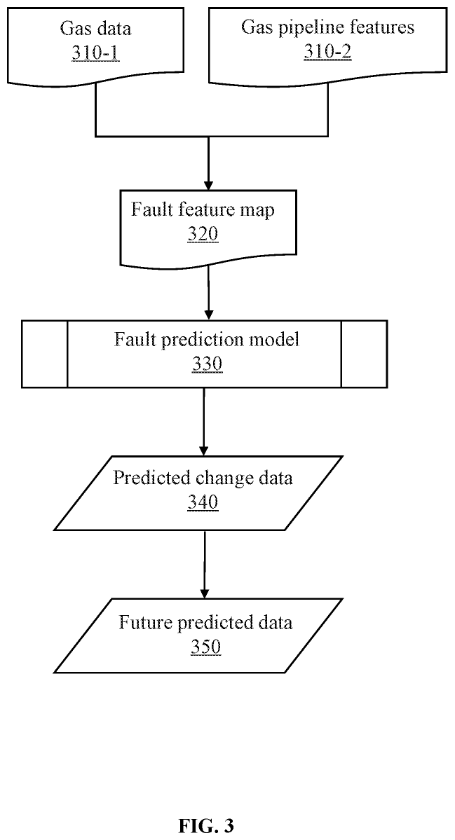

In some embodiments, the smart gas pipeline network safety management platform may determine the future predicted data based on predicted change data. More descriptions may be found in FIG. 3 and related descriptions thereof.

In 230, a future fault pipeline may be determined based on the future predicted data.

The future fault pipeline refers to a pipeline of the gas pipeline network system that may have a fault at a future time point.

In some embodiments, the smart gas pipeline network safety management platform may determine the future fault pipeline in various ways. For example, the smart gas pipeline network safety management platform may directly determine a pipeline with the predicted fault time point closest to current time as the future fault pipeline.

In some embodiments, the smart gas pipeline network safety management platform may determine the future fault pipeline based on the future predicted data and a first predetermined time threshold.

In some embodiments, the future predicted data may include a predicted fault location. The first predetermined time threshold may be positively correlated to a degree of importance of a pipeline corresponding to the predicted fault location. The pipeline corresponding to the predicted fault location refers to a pipeline where the predicted fault location is located.

The predicted fault location refers to a predicted location of a pipeline fault. Since the future predicted data may include the predicted fault location, once the future predicted data is determined, the predicted fault location may also be determined.

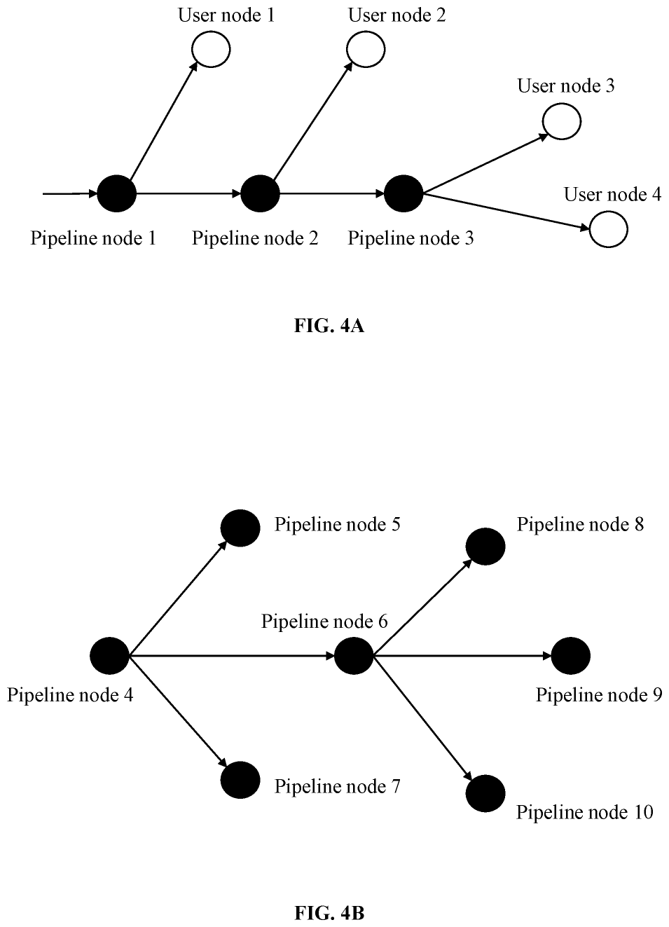

FIG. 4A is a schematic diagram illustrating an exemplary degree of importance of a pipeline according to some embodiments of the present disclosure.

FIG. 4A shows a pipeline image, which is an image used to represent information about gas flow between a pipeline and a user.

In some embodiments, the pipeline image may be constructed based on a pipeline route, and the pipeline image may include pipeline nodes and user nodes.

The pipeline nodes refer to nodes corresponding to gas pipelines.

The user nodes refer to nodes corresponding to the gas users.

In some embodiments, edges in the pipeline image may correspond to flow paths of the gas. The edges in the pipeline image may be directed edges, and directions of the edges may correspond to directions of the gas flow.

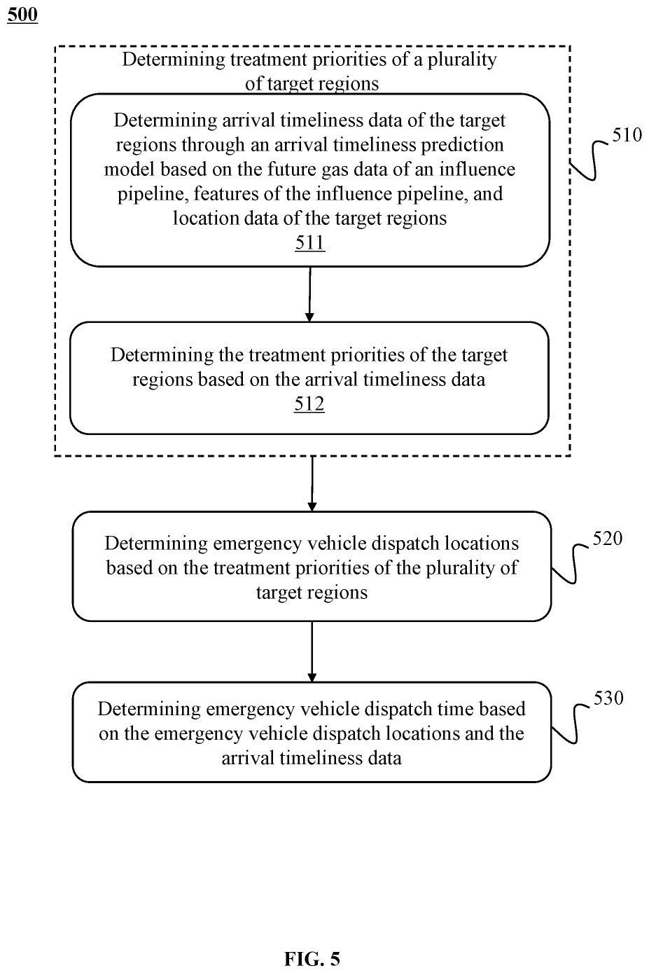

In some embodiments, the smart gas pipeline network safety management platform may calculate the degree of importance of the pipeline based on the pipeline image through a predetermined algorithm. The predetermined algorithm may be: the degree of importance of the pipeline=Σᵢ₌₁ⁿkᵢ*Cᵢ, where n is a count of paths to all the user nodes that can be reached by starting from the pipeline nodes and following the directions of the gas flow, kᵢ is a path coefficient of an ith path, and Cᵢ is a degree of importance of an end node of the ith path. The end node refers to a node of which an in-degree is not 0 and an out-degree is 0 (e.g., a user node 1). The in-degree of a node refers to a count of arrows pointing to the node, while the out-degree of the node refers to a count of arrows pointing out from the node. As shown in FIG. 4A, an in-degree of a pipeline node 3 is 1, and an out-degree of the pipeline node 3 is 2. The end node in the pipeline image may be understood as a node that gas no longer flows out to other nodes after flowing to the node. The degree of importance of the end node refers to a degree of importance of a user corresponding to that end node. The descriptions regarding determining the degree of importance of the user may be found in FIG. 5 and related descriptions thereof.

In some embodiments, the path coefficient may be positively correlated with a path length. The path length refers to a count of nodes in the pipeline image that the path passes from the pipeline node to the end node, i.e., an adjacency of start and end points of the path in the pipeline image. For example, a path may be formed from a pipeline node 1 to a user node 2, where the user node 2 may be the end node of the path, and nodes that the path passes may be represented as pipeline node 1-pipeline node 2-user node 2. Therefore, an adjacency of the pipeline node 1 and the user node 2 is 2, i.e., a path length of the path from the pipeline node 1 to the user node 2 is 2.

It can be understood that the more upstream the pipeline node is located and the more branches, the higher the degree of importance of the pipeline node. For example, a fault of the pipeline node 3 may affect a user node 3 and a user node 4; similarly, a fault of the pipeline node 1 may affect the pipeline nodes 2, 3 and the user nodes 1, 2, 3, 4.

In some embodiments, the first predetermined time threshold may be positively correlated with the degree of importance of the pipeline corresponding to the predicted fault location.

In some embodiments of the present disclosure, the first predetermined time threshold may be positively correlated with the degree of importance of the pipeline corresponding to the predicted fault location, so that emergency gas supply may be performed for an important pipeline as a future fault pipeline even fault occurrence time of the pipeline is long after the present time. The flexible adjustment of the first predetermined time threshold may make the subsequent emergency vehicle dispatch instruction better meet actual requirements.

The purpose of determining the future fault pipeline may be to dispatch an emergency vehicle. If a predicted fault time point is long after the present time, there is no need to dispatch the emergency vehicle at the present time. Accordingly, in some embodiments, a pipeline whose predicted fault time point meets the first predetermined time threshold may be determined as the future fault pipeline. The predicted fault time point meeting the first predetermined time threshold means that a time interval between a current time point and the predicted fault time point is less than the first predetermined time threshold. For example, if a fault prediction model determines that a pipeline node will experience a fault after 5 hours in the future, and the first predetermined time threshold is 8 hours, a pipeline corresponding to the pipeline node may be determined as the future fault pipeline. As the future predicted data may include the predicted fault time point, once the future predicted data is determined, the predicted fault time point may also be determined. More descriptions regarding the fault prediction model may be found in FIG. 3 and related descriptions thereof.

In some embodiments of the present disclosure, determining the future fault pipeline based on the future predicted data and the first predetermined time threshold may help determine the pipeline whose predicted fault time point is relatively close to the current time as the future fault pipeline, thereby achieving the effect of emergency gas supply.

In 240, target regions may be determined based on the future fault pipeline.

The target regions refer to regions where the emergency vehicle needs to reach. In some embodiments, the target regions may include a first predicted target region.

The first predicted target region refers to a region of which gas supply is directly affected in the event of a gas pipeline fault. For example, the first predicted target region may include a residential region directly connected to the future fault pipeline.

In some embodiments, the smart gas pipeline network safety management platform may determine regions of which gas supply is affected as the target regions based on the future fault pipeline in conjunction with the gas pipeline network system. In some embodiments, the smart gas pipeline network safety management platform may determine regions corresponding to downstream user nodes of gas flow of the future fault pipeline as the regions of which gas supply is affected based on the pipeline image.

In some embodiments, the smart gas pipeline network safety management platform may identify a region corresponding to the future fault pipeline as the first predicted target region.

The region corresponding to the future fault pipeline refers to a region directly connected with the future fault pipeline.

In some embodiments of the present disclosure, identifying the region corresponding to the future fault pipeline as the first predicted target region helps to quickly and efficiently determine the region of which gas supply is directly affected, and improves the efficiency of determining the first predicted target region.

In some embodiments, the target regions may further include a second predicted target region.

The second predicted target region refers to a region of which gas supply is indirectly affected in the event of a gas pipeline fault.

In some embodiments, the smart gas pipeline network safety management platform may identify a region connected with a downstream pipeline directly connected with the future fault pipeline as the second predicted target region.

In some embodiments, the smart gas pipeline network safety management platform may determine a candidate predicted association pipeline based on the future fault pipeline; determine a predicted association pipeline based on the candidate predicted association pipeline and the future predicted data; and determine the second predicted target region based on the predicted association pipeline.

FIG. 4B is a schematic diagram illustrating an exemplary candidate predicted association pipeline according to some embodiments of the present disclosure. FIG. 4B is another pipeline image. Nodes in the pipeline image may corresponding to pipeline nodes other than the user nodes, and edges may correspond to flow paths of gas.

The candidate predicted association pipeline refers to a pipeline that may become the predicted association pipeline.

In some embodiments, the smart gas pipeline network safety management platform may determine a sibling pipeline of the future fault pipeline and a downstream pipeline directly connected with the future fault pipeline as the candidate predicted association pipelines. For example, as shown in FIG. 4B, if a pipeline 4-6 (i.e., a pipeline composed of pipeline nodes 4 and 6) is determined as the future fault pipeline, the candidate predicted association pipelines may include sibling pipelines 4-5 and 4-7, and downstream pipelines 6-8, 6-9, and 6-10.

The predicted association pipeline refers to a pipeline that has a certain correlation with the predicted future fault pipeline.

In some embodiments, the smart gas pipeline network safety management platform may determine the predicted association pipeline based on future gas data and the candidate predicted association pipeline. The future gas data may be determined based on a fault prediction model. More descriptions regarding the fault prediction model may be found in the descriptions of FIG. 3.

In some embodiments, within a second predetermined time threshold after a predicted fault time point, if a degree of change in the future gas data of a candidate predicted association pipeline is greater than a change threshold, the candidate predicted association pipeline may be determined as the predicted association pipeline. For example, if the predicted fault time point of the future fault pipeline is 13:00, the second predetermined time threshold is 2 h, and the degree of change in the future gas data of the candidate predicted association pipeline between 13:00 and 15:00 is m and is greater than a change threshold n, the candidate predicted association pipeline may be the predicted association pipeline.

The second predetermined time threshold and the change threshold may be determined based on historical experience. The smart gas pipeline network safety management platform may calculate a weighted value of a degree of change in future gas flow data, future gas pipeline temperature data, and future gas pipeline air pressure data as the degree of change in the future gas data.

In some embodiments, the smart gas pipeline network safety management platform may use a region directly affected by the predicted association pipeline as the second predicted target region.

In some embodiments of the present disclosure, the second predicted target region may be determined through the predicted association pipeline, so that the influence of both sibling and downstream pipelines is considered, and the introduction of the change threshold and the second predetermined time threshold can filter out pipelines with a low degree of influence from the future fault pipeline, thereby accurately determining the second predicted target region.

In some embodiments of the present disclosure, the determination of the second predicted target region may expand the range of the target regions, facilitating emergency dispatch to the regions indirectly affected by the future fault pipeline.

In 250, an emergency vehicle dispatch instruction may be determined based on the target regions.

In some embodiments, the emergency vehicle dispatch instruction may include at least one of an emergency vehicle dispatch location and emergency vehicle dispatch time.

In some embodiments, the smart gas pipeline network safety management platform may determine the emergency vehicle dispatch instruction in various ways. For example, the smart gas pipeline network safety management platform may determine the emergency vehicle dispatch instructions through preset rules. An exemplary preset rule may be that the target regions corresponding to pipelines of higher degree of importance may be prioritized as the emergency vehicle dispatch locations, and the earlier the emergency vehicle dispatch time may be.

In some embodiments, the smart gas pipeline network safety management platform may determine the emergency vehicle dispatch instruction based on treatment priorities of the target regions. More descriptions may be found in FIG. 5 and related descriptions thereof.

In some embodiments of the present disclosure, the future fault pipeline and the target regions may be determined through the future predicted data, and then the emergency dispatch instruction may be determined, so that emergency vehicles may be dispatched before the occurrence of the gas pipeline fault, thereby solving the issue of delayed gas supply, improving the stability of gas supply, and enhancing the user experience for the gas users.

In some embodiments, the target regions may further include a first actual target region and a second actual target region. In some embodiments, the smart gas pipeline network safety management platform may determine the first actual target region based on an actual fault pipeline; determine an actual association pipeline based on the actual fault pipeline; and determine the second actual target region based on the actual association pipeline.

The first actual target region refers to a region of which gas supply is directly affected in the event of an actual pipeline fault.

The actual fault pipeline refers to a pipeline that is currently experiencing a fault. In some embodiments, the smart gas pipeline network safety management platform may obtain the actual fault pipeline based on the smart gas data center. For example, the smart gas pipeline network safety management platform may access the pipeline that is currently experiencing fault and stored in the smart gas data center as the actual fault pipeline.

Determining the first actual target region may be similar to determining the first predicted target region as described above.

The second actual target region refers to a region of which gas supply is indirectly affected in the event of an actual fault of a pipeline.

The actual association pipeline refers to a pipeline that has a certain correlation with the actual fault pipeline.

In some embodiments, the smart gas pipeline network safety management platform may determine a candidate actual association pipeline based on the actual fault pipeline; determine the future predicted data of the gas pipeline network system based on the gas data and the gas pipeline features; and determine the actual association pipeline based on the candidate actual association pipeline and the future predicted data. The future predicted data refers to predicted data after an actual fault time point. The determination of the actual association pipeline in a specific manner similar to the determination of the predicted association pipeline as described above.

The determination of the second actual target region may be similar to the determination of the second predicted target region as described above.

In some embodiments of the present disclosure, the determination of the first actual target region and the second actual target region helps with the emergency dispatch work for the region affected by the actual fault pipeline, thereby ensuring the stability of gas supply.

FIG. 3 is a schematic diagram illustrating an exemplary process of determining future predicted data according to some embodiments of the present disclosure.

In some embodiments, as shown in FIG. 3, the smart gas pipeline network safety management platform may construct a fault feature map 320 based on gas data 310-1 and gas pipeline features 310-2; determine future predicted data 320 is determined by a fault prediction model 330, determining predicted change data 340 through a fault prediction model 330 based on the fault feature map 320; and determine future predicted data 350 based on the predicted change data 340.

In some embodiments, the fault feature map 320 may include nodes and edges. The nodes may have node features, and the edges may have edge features.

The nodes may include gas pipeline nodes and pipeline valve nodes. In some embodiments, the gas pipeline nodes may be a midpoint location of a pipeline, or may be that a pipeline is divided (e.g., a division point is set up every 5 m), and each division point is a node.

In some embodiments, the node features may include gas pipeline node features and pipeline valve node features.

Specifically, the gas pipeline node features may include the gas data 310-1, the gas pipeline features 310-2, environmental data, location data, and maintenance data. The gas data 310-1 may include gas flow data, gas pipeline temperature data, gas pipeline air pressure data, or the like. The gas pipeline features 310-2 may include an inner diameter, a material, a length, or the like, of a pipeline. The environmental data may include external temperature, rainfall, precipitation pH, or the like. The maintenance data may include a historical maintenance frequency, last maintenance time, or the like. The environmental data may be data of a plurality of future time points obtained based on a third-party platform.

Correspondingly, the pipeline valve node features may include gas data, operation parameters (e.g., degree of valve opening and closing), environmental data, maintenance data, or the like.

The edges may correspond to the gas pipelines. Directions of the edges may be directions of gas flow.

The edge features may include a length corresponding to a gas pipeline.

The predicted change data 340 refers to data obtained by prediction related to gas features, gas pipeline faults, or the like. In some embodiments, the predicted change data 340 may include whether the nodes have a fault, a predicted fault time point, a predicted fault type, predicted gas data, or the like. For example, the predicted change data 340 may be (ai, 0, 0, 0, m₁), (az, 1, 13:20, x, m₂). The first element represents a node No. (e.g., ai represents a node 1, and az represents a node 2), the second element indicates whether a fault occurs (e.g., 0 represents no fault, and 1 represents the fault), the third element represents fault time (e.g., 0 represents no corresponding fault time, and 13:20 represents the fault time as 13:20), the fourth element represents the fault type (e.g., 0 represents no corresponding fault type, and x represents the fault type as x), and the fifth element represents the predicted gas data (e.g., m₁ represents predicted gas data 1, and m₂ represents predicted gas data 2).

In some embodiments, the smart gas pipeline network safety management platform may predict various types of faults that may occur in the gas pipeline based on the fault prediction model 330.

In some embodiments, the fault prediction model 330 may be a deep learning neural network model, etc. For example, the fault prediction model may be a Graph Neural Network (GNN), etc.

In some embodiments, an input of the fault prediction model 330 may be the fault feature map 320, and an output of the fault prediction model 330 may be the predicted change data 350.

In some embodiments, the fault prediction model 330 may be trained based on a large number of first training samples with first labels. Specifically, the first training samples with the first labels may be input into an initial fault prediction model, a loss function may be constructed through the first labels and prediction results of the initial fault prediction model, and the initial fault prediction model may be iteratively updated based on the loss function. The training may be completed when the loss function of the initial fault prediction model satisfies a predetermined condition. The predetermined condition may be that the loss function converges, or a count of iterations reaches a threshold.

In some embodiments, the first training samples may include a sample fault feature map. The first training samples may be obtained based on historical data. In some embodiments, the first labels may include future predicted data corresponding to the first training samples. In some embodiments, the first labels refer to actually measured data after historical time corresponding to a sample fault feature map.

In some embodiments, the smart gas pipeline network safety management platform may determine the future predicted data 350 based on the predicted change data 340 output by the fault prediction model 330. For example, the smart gas pipeline network safety management platform may determine a pipeline corresponding to a fault node as a fault pipeline, and determine a location of the fault node as a predicted fault location of the fault pipeline. The corresponding pipeline refers to a pipeline where the fault node is located.

In response to a determination that there is only one fault node on the fault pipeline, the smart gas pipeline network safety management platform may determine fault time of the fault node as fault time of the corresponding pipeline, and determine the future gas data of the fault node as the future gas data of the corresponding pipeline. In response to a determination that there are a plurality of fault nodes on the fault pipeline, the smart gas pipeline network safety management platform may determine fault time of a fault node with earliest fault time among the plurality of fault nodes as the fault time of the fault pipeline; and determine an average value of the future gas data of the plurality of fault nodes as the future gas data of the fault pipeline.

In some embodiments of the present disclosure, the accurate predicted change data can be efficiently determined by the fault prediction model 330 based on the fault feature map 320, thereby improving the accuracy and efficiency of obtaining the future predicted data 350.

FIG. 5 is a flowchart illustrating an exemplary process of determining an emergency vehicle dispatch instruction according to some embodiments of the present disclosure. In some embodiments, a process 500 may be performed based on the smart gas pipeline network safety management platform. As shown in FIG. 5, the process 500 may include the following operations.

In 510, treatment priorities of a plurality of target regions may be determined. The determining the treatment priority of a target region may include the following operations.

In 511, arrival timeliness data of the target region may be determined through an arrival timeliness prediction model based on the future gas data of an influence pipeline, features of the influence pipeline, and location data of the target region.

More descriptions regarding the future gas data may be found in FIG. 2 and related descriptions thereof.

The influence pipeline refers to a pipeline affecting the target region. For example, if the target region is determined based on a pipeline X, the pipeline X may be the influence pipeline of the target region. The features of the influence pipeline may include a location, a length, or the like, of the influence pipeline.

In some embodiments, the location data of the target region may include location data of the first predicted target region and the second predicted target region. In some embodiments, the smart gas pipeline network safety management platform may issue an instruction for obtaining the location data of the target region to obtain the location data transmitted by the smart gas pipeline network sensor platform.

In some embodiments, the arrival timeliness prediction model may be a machine learning model. For example, the arrival timeliness prediction model may be a convolutional neural network (CNN) model.

An input of the arrival timeliness prediction model may include the future gas data of the influence pipeline, the features of the influence pipeline, and the location data of the target region; and an output of the arrival timeliness prediction model may include the arrival timeliness data.

The arrival timeliness data refers to numerical values or letters that reflect different arrival times of emergency vehicles and corresponding timeliness effects thereof. For example, the timeliness effect may be represented by scores ranging from 0 to 100, with lower scores indicating poorer effects. The arrival timeliness data may be represented as ((t₁, q₁), (t₂, q₂), (t₃, q₃)), where t₁, t₂, and t₃ represent first, second, and third arrival times, respectively, and q₁, q₂, and q₃ represent timeliness effects corresponding to the first, second, and third arrival times, respectively.

In some embodiments, the input of the arrival timeliness prediction model may also include regional data for the target region.

The regional data may include a gas consumption scale at different times in the region. For example, a region has an average gas consumption of x cubic meters per day from 12:00 to 14:00 and an average gas consumption of y cubic meters per day from 14:00 to 16:00. In some embodiments, the smart gas pipeline network safety management platform may determine the regional data of the target region based one historical data of the target region. For example, the smart gas pipeline network safety management platform may use a mean or a median of the historical data of the target region as the regional data of the target region.

In some embodiments of the present disclosure, by inputting the regional data of the target region into the arrival timeliness prediction model, the arrival timeliness data can be more accurately determined in conjunction with the regional data.

In some embodiments, the arrival timeliness prediction model may be obtained by training a plurality of second training samples with second labels. For example, the plurality of second training samples with the second labels may be input to an initial arrival timeliness prediction model. A loss function may be constructed based on the second labels and prediction results of the initial arrival timeliness prediction model. The initial arrival timeliness prediction model may be iteratively updated based on the loss function. The training may be completed when the loss function of the initial arrival timeliness prediction model satisfies a predetermined condition. The predetermined condition may be that the loss function converges, or a count of iterations reaches a threshold.

In some embodiments, the second training samples may include future gas data of sample influence pipelines, features of sample influence pipelines, and location data of sample target regions. The second training samples may be obtained based on historical data. In some embodiments, the second labels may include arrival timeliness data corresponding to the second training samples. In some embodiments, the smart gas pipeline network safety management platform may record arrival time of the emergency vehicle after each emergency gas supply task and survey a public evaluation of the target region to determine the timeliness effect. The lower the public evaluation, the worse the timeliness effect.

In some embodiments, the smart gas pipeline network safety management platform may directly use a mean value of public evaluation scores as the timeliness effect or query a preset table to determine the timeliness effect. The preset table may be a preset table representing a correspondence between the mean value of the public evaluation scores and the timeliness effect.

In 512, treatment priorities of target regions may be determined based on the arrival timeliness data.

The treatment priorities refer to an order in which different target regions are treated. For example, when there are 5 first predicted target regions and 10 second predicted target regions, and there are 10 emergency vehicles currently available, a treatment order of the target regions may be determined. In some embodiments, the higher the treatment priority, the earlier the treatment order.

In some embodiments, the treatment priority may be determined based on a treatment priority score. The higher the treatment priority score, the higher the treatment priority. In some embodiments, the formula for calculating the treatment priority score may be: treatment priority score=[(factor 1* count of users+factor 2* degree of user importance+factor 3* effective arrival time)] * factor 4. The count of users refers to a count of users in the target region, which may be obtained based on the smart gas user platform and transmitted to the smart gas pipeline network safety management platform through the smart gas service platform.

In some embodiments, the degree of user importance may be positively correlated with gas usage, user time of gas supply, and a probability of payment on time. The user time of gas supply refers to gassed means the time when the user starts to use gas.

In some embodiments, factor 3 may be negative, i.e., the shorter the effective arrival time, the higher the treatment priority score. The effective arrival time refers to a latest time point at which the timeliness effect of the emergency vehicle arriving at the target region for gas supply meets an effect threshold. In some embodiments, the effective arrival time may be arrival time with the largest value among a count of different arrival times corresponding to the timeliness effect that is greater than the effect threshold. For example, the arrival timeliness data output by the arrival timeliness prediction model may be ((0.5, 100), (1, 90), (1.5, 60), (2, 30)), the preset effect threshold may be 50, and the effective arrival time may be 1.5 h.

In some embodiments, the factor 4 of the first predicted target region may be greater than the factor 4 of the second predicted target region.

In 520, emergency vehicle dispatch locations may be determined based on the treatment priorities of the plurality of target regions.

The emergency vehicle dispatch locations refer to the target regions where the emergency vehicles need to be dispatched.

In some embodiments, the smart gas pipeline network safety management platform may determine the emergency vehicle dispatch locations in various ways. For example, if one emergency vehicle can be directly dispatched to each emergency vehicle dispatch location without considering that a regional recommended gas supply volume is greater than a capacity of the emergency vehicle, the smart gas pipeline network safety management platform may directly determine the emergency vehicle dispatch locations based on the order of the treatment priorities. As another example, if there are 15 target regions and 10 emergency vehicles, the smart gas pipeline network safety management platform may determine the first 10 target regions with the higher treatment priorities as the emergency vehicle dispatch locations.

In some embodiments, the smart gas pipeline network safety management platform may determine the regional recommended gas supply volume for the target region based on the fault type of the future fault pipeline corresponding to the target region, the regional data of the target region, and a distance between the emergency vehicle and the future fault pipeline corresponding to the target region. In response to a determination that the regional recommended gas supply volume is greater than the capacity of the emergency vehicle, a preparatory treatment plan may be determined; and the emergency vehicle dispatch locations may be determined based on the treatment priorities of the plurality of target regions and the preparatory treatment plan. More descriptions regarding the regional data may be found in the preceding descriptions.

The fault type of the future fault pipeline refers to a fault type to which the future fault pipeline belongs. For example, the fault type may include gas leakage, pipeline corrosion, pipeline cracks, or the like, of the gas pipeline. In some embodiments, the smart gas pipeline network safety management platform may determine the fault type based on the future predicted data. More descriptions regarding the future predicted data may be found in the related descriptions of FIG. 3.

In some embodiments, the smart gas pipeline network safety management platform may calculate the distance between the emergency vehicle and the future fault pipeline corresponding to the target region based on the location of the emergency vehicle and the location of the future fault pipeline.

The regional recommended gas supply volume for the target region refers to a recommended gas supply volume of the target region.

In some embodiments, the smart gas pipeline network safety management platform may construct a current feature vector based on the fault type, the regional data, and the distance between the emergency vehicle and the future fault pipeline corresponding to the target region, search for a reference feature vector from a vector database that has the highest similarity to the current feature vector, and then use a regional recommended gas supply volume corresponding to the reference feature vector as the regional recommended gas supply volume corresponding to the current feature vector. The vector database may include a plurality of sets of reference feature vectors composed of a plurality of historical fault types, regional data, distances between the emergency vehicles and the future fault pipelines corresponding to the target regions, and regional recommended gas supply volumes corresponding to the plurality of sets of reference feature vectors.

The capacity of the emergency vehicle refers to a maximum gas volume that the emergency vehicle can store.

The preparatory treatment plan refers to an alternative plan for target regions where the regional recommended gas supply volume exceeds the capacity of the emergency vehicle.

In some embodiments, for simplification purposes, in the target regions where the regional recommended gas supply volume exceeds the capacity of the emergency vehicle, the preparatory treatment plan may be to directly dispatch one or more additional emergency vehicles to the target regions. In some embodiments, if there are a plurality of target regions where the regional recommended gas supply volume exceeds the capacity of the emergency vehicle, the preparatory treatment plan may be that the plurality of target regions share one emergency vehicle. The following are all illustrated by the example of directly dispatching one additional emergency vehicle.

In some embodiments, the smart gas pipeline network safety management platform may determine the emergency vehicle dispatch locations based on the treatment priorities of the plurality of target regions and the preparatory treatment plan. For example, the smart gas pipeline network safety management platform may dispatch the emergency vehicles to the target regions in order of the treatment priorities and determine the target region where two emergency vehicles need to be dispatched based on the preparatory treatment plan. For example, when the target region requires two emergency vehicles, the smart gas pipeline network safety management platform may dispatch two emergency vehicles; when the target region requires one emergency vehicle, the smart gas pipeline network safety management platform may dispatch one emergency vehicle. If all emergency vehicles are dispatched, the previously dispatched target regions are determined as the emergency vehicle dispatch locations. If only one emergency vehicle is left for the last target region requiring two emergency vehicles, the smart gas pipeline network safety management platform may first dispatch one emergency vehicle, and dispatch the second emergency vehicle to the target region after other emergency vehicles complete their tasks.

In some embodiments of the present disclosure, the required gas supply volume varies with different time periods and gas consumption in different target regions. Accordingly, the preparatory treatment plan may be determined based on the regional recommended gas supply volume, and the preparatory treatment plan may be adjusted based on actual situations. The emergency vehicle dispatch locations are determined based on the treatment priorities and the preparatory treatment plan, which helps meet the high gas supply demand of the target regions.

In 530, emergency vehicle dispatch time may be determined based on the emergency vehicle dispatch locations and the arrival timeliness data.

In some embodiments, the smart gas pipeline network safety management platform may determine the emergency vehicle dispatch time based on travel time. The travel time refers to time required for the emergency vehicle to reach the emergency vehicle dispatch location. The travel time may be calculated by dividing a distance between the emergency vehicle and the target region, which is determined based on the location data of the target region and a dispatch center location, by an average speed of the emergency vehicle.

In some embodiments, the smart gas pipeline network safety management platform may consider any time point that is less than the effective arrival time when added to the travel time as the emergency vehicle dispatch time. For example, if the effective arrival time is 5:00 p.m., and the travel time from the dispatch center to the emergency vehicle dispatch location is 1.5 h, the emergency vehicle dispatch time should be before 3:30 p.m. More descriptions regarding the effective arrival time may be found in the previous descriptions.

In some embodiments of the present disclosure, the emergency vehicle dispatch locations are determined based on the treatment priorities of the target regions, and then the emergency vehicle dispatch time is determined. This allows prioritizing the dispatch of the emergency vehicle to the target region with a higher treatment priority, thereby improving the effect of emergency gas supply, and improving the gas usage experience for users.

In some embodiments, in response to the target regions including the first actual target region, the second actual target region, the first predicted target region, and the second predicted target region, the smart gas pipeline network safety management platform may determine the treatment priorities of the plurality of target regions. Furthermore, the smart gas pipeline network safety management platform may determine the emergency vehicle dispatch locations based on the treatment priorities of the plurality of target regions, and determine the emergency vehicle dispatch time based on the emergency vehicle dispatch locations and the arrival timeliness data.

More descriptions regarding determining the treatment priorities and the treatment priority scores may be found in the relevant descriptions. When the treatment priority scores are calculated, the magnitudes of the factors 4 of different target regions may be difference, and the first actual target region>the second actual target region>the first predicted target region>the second predicted target region.

The determination of the emergency vehicle dispatch location and the emergency vehicle dispatch time is similar to that of the previous descriptions, which can be found above.

In some embodiments of the present disclosure, the emergency vehicle dispatch instruction is determined through the treatment priorities of the plurality of target regions, so that the first actual target region and the second actual target region can be prioritized for dispatching emergency vehicles compared to the first predicted target region and the second predicted target region, thereby improving the intelligence of disposing emergency gas supply.

When the operations performed in the embodiments of the present disclosure are described in terms of steps, unless otherwise indicated, the order of the steps is reversible, the steps may be omitted, and other steps may be included in the operation process.

The embodiments in the present disclosure are merely exemplary and illustrative, and do not limit the scope of the present disclosure. For those skilled in the art, various modifications and changes that can be made under the guidance of the present disclosure are still within the scope of the present disclosure.

Some features, structures, or characteristics of one or more embodiments in the present disclosure may be appropriately combined.

Numerical values used to describe attributes, quantities, or the like in some embodiments should be understood to be modified by terms such as “approximately,” “nearly,” or “substantially” in some examples. Unless otherwise specified, terms such as “about,” “approximately,” or “roughly” indicate that a variation of ±20% in the stated numbers is allowed. Correspondingly, in some embodiments, the numerical parameters used in the present disclosure and claims are approximations, which may change depending on the desired characteristics of individual embodiments. In some embodiments, the numerical parameters should consider the specified number of valid digits and use a general digit retention method. While the numerical domains and parameters used to confirm the breadth of their ranges in some embodiments of the present disclosure are approximations, in specific embodiments, such values are set to be as precise as possible within a feasible range.

In case of any inconsistency or conflict between the descriptions, definitions, and/or use of terms in the materials cited in the present disclosure and those described in the present disclosure, the descriptions, definitions, and/or use of terms in the present disclosure shall prevail.

What is claimed is:

1. A method for disposing emergency gas supply of smart gas, implemented by a smart gas pipeline network safety management platform, comprising:
obtaining gas data based on a data acquisition device, the gas data including at least one of gas flow data, gas pipeline temperature data, and gas pipeline air pressure data;
determining future predicted data of a gas pipeline network system based on the gas data and gas pipeline features, the future predicted data including predicted pipeline fault data, and future gas data;
determining a future fault pipeline based on the future predicted data;
determining target regions based on the future fault pipeline, the target regions including a first predicted target region; and
determining an emergency vehicle dispatch instruction based on the target regions, the emergency vehicle dispatch instruction including at least one of an emergency vehicle dispatch location, and emergency vehicle dispatch time.

2. The method of claim 1, wherein the determining future predicted data of a gas pipeline network system based on the gas data and gas pipeline features includes:
constructing a fault feature map based on the gas data and the gas pipeline features;
determining predicted change data through a fault prediction model based on the fault feature map, the fault prediction model being a machine learning model; and
determining the future predicted data based on the predicted change data.

3. The method of claim 2, wherein the determining a future fault pipeline based on the future predicted data includes:
determining the future fault pipeline based on the future predicted data, and a first predetermined time threshold.

4. The method of claim 3, wherein the determining a first predicted target region includes:
determining a region corresponding to the future fault pipeline as the first predicted target region.

5. The method of claim 3, wherein the future predicted data includes a predicted fault location, and the first predetermined time threshold is positively correlated to a degree of importance of a pipeline corresponding to the predicted fault location.

6. The method of claim 4, wherein the target regions further include a second predicted target region.

7. The method of claim 6, wherein determining the second predicted target region includes:
determining a candidate predicted association pipeline based on the future fault pipeline;
determining a predicted association pipeline based on the candidate predicted association pipeline and the future predicted data; and
determining the second predicted target region based on the predicted association pipeline.

8. The method of claim 1, wherein the determining an emergency vehicle dispatch instruction based on the target regions includes:
for each of the target regions,
determining arrival timeliness data of the target region through an arrival timeliness prediction model based on future gas data of an affected pipeline, features of the affected pipeline, and location data of the target region, the arrival timeliness prediction model being a machine learning model;
determining a treatment priority of the target region based on the arrival timeliness data;
determining the emergency vehicle dispatch location based on treatment priorities of the target regions; and
determining the emergency vehicle dispatch time based on the emergency vehicle dispatch location and the arrival timeliness data.

9. The method of claim 8, wherein an input of the arrival timeliness prediction model further includes regional data of the target regions.

10. The method of claim 8, wherein the determining the emergency vehicle dispatch location based on the treatment priorities of the target regions includes:
for each of the target regions,
determining a regional recommended gas supply volume based on a fault type of a future fault pipeline corresponding to the target region, regional data of the target region, and a distance between an emergency vehicle and the future fault pipeline corresponding to the target region;
in response to a determination that the regional recommended gas supply volume is greater than a capacity of the emergency vehicle, determining a reserve treatment program; and
determining the emergency vehicle dispatch location based on the treatment priorities of the target regions and the reserve treatment program.

11. The method of claim 1, wherein the target regions may further include a first actual target region and a second actual target region;
determining the first actual target region includes:
determining the first actual target region based on an actual fault pipeline; and
determining the second actual target region includes:
determining an actual association pipeline based on the actual fault pipeline; and
determining the second actual target region based on the actual association pipeline.

12. The method of claim 11, wherein the determining an emergency vehicle dispatch instruction based on the target regions includes:
in response to a determination that the target regions include the first actual target region, the second actual target region, the first predicted target region, and second predicted target region,
determining treatment priorities of the target regions;
determining the emergency vehicle dispatch location based on the treatment priorities of the target regions; and
determining the emergency vehicle dispatch time based on the emergency vehicle dispatch location and the arrival timeliness data.

13. An Internet of Things (IoT) system for disposing emergency gas supply of smart gas, comprising a smart gas user platform, a smart gas service platform, a smart gas pipeline network safety management platform, a smart gas pipeline network sensor network platform, and a smart gas pipeline network object platform which interact in sequence, wherein the smart gas pipeline network safety management platform is configured to:
obtain gas data based on a data acquisition device, the gas data including at least one of gas flow data, gas pipeline temperature data, and gas pipeline air pressure data;
determine future predicted data of a gas pipeline network system based on the gas data and gas pipeline features, the future predicted data including predicted pipeline fault data, and future gas data;
determine a future fault pipeline based on the future predicted data;
determine target regions based on the future fault pipeline, the target regions including a first predicted target region; and
determine an emergency vehicle dispatch instruction based on the target regions, the emergency vehicle dispatch instruction including at least one of an emergency vehicle dispatch location, and emergency vehicle dispatch time.

14. The IoT system of claim 13, wherein the smart gas user platform includes a gas user sub-platform and a supervisory user sub-platform, the gas user sub-platform corresponds to a gas user, and the supervisory user sub-platform corresponds to a supervisory user; and
the smart gas service platform includes a smart gas usage service sub-platform and a smart supervision service sub-platform, the smart gas usage service sub-platform corresponds to a gas user sub-platform, and the smart supervision service sub-platform corresponds to a supervisory user sub-platform.

15. The IoT system of claim 13, wherein the smart gas pipeline network safety management platform includes an smart gas pipeline network risk assessment and management sub-platform and an smart gas data center, the smart gas pipeline network risk assessment and management sub-platform bi-directionally interact with the smart gas data center, and the smart gas pipeline network risk assessment and management sub-platform obtains data from the smart gas data center and feeds back operation information corresponding to the data to the smart gas data center.

16. The IoT system of claim 13, wherein the smart gas pipeline network sensor network platform includes a smart gas pipeline network equipment sensor network sub-platform and a smart gas pipeline network maintenance engineering sensor network sub-platform; and
the smart gas pipeline network object platform includes a smart gas pipeline network equipment object sub-platform and a smart gas pipeline network maintenance engineering object sub-platform, wherein the smart gas pipeline network equipment object sub-platform corresponds to the smart gas pipeline network equipment sensor network sub-platform, and the smart gas pipeline network maintenance engineering object sub-platform corresponds to the smart gas pipeline network maintenance engineering sensor network sub-platform.

17. The IoT system of claim 13, wherein the smart gas pipeline network safety management platform is further configured to:
construct a fault feature map based on the gas data and the gas pipeline features;
determine predicted change data through a fault prediction model based on the fault feature map, the fault prediction model being a machine learning model; and
determine the future predicted data based on the predicted change data.

18. The IoT system of claim 13, wherein the smart gas pipeline network safety management platform is further configured to:
determine the future fault pipeline based on the future predicted data, and a first predetermined time threshold, the future predicted data including a predicted fault location.

19. The IoT system of claim 13, wherein the smart gas pipeline network safety management platform is further configured to:
determine a region corresponding to the future fault pipeline as the first predicted target region.

20. A non-transitory computer-readable storage medium, comprising computer instructions that, when read by a computer, direct the computer to implement the method for disposing emergency gas supply of smart gas of claim 1.
